(19) United States
(12) Patent Application Publication
(10) Pub. No.: US 2008/0224588 A1
(43) Pub. Date: Sep. 18, 2008

(54) CHASSIS ASSEMBLY STRUCTURE OF A GRILLER

(76) Inventor: Lucas PAI, Taichung City (TW)

Correspondence Address: EGBERT LAW OFFICES, 412 MAIN STREET, 7TH FLOOR, HOUSTON, TX, 77002, US

(21) Appl. No.: 11/685,041

(22) Filed: Mar. 12, 2007

(51) Int. Cl. A47J 37/07

(52) U.S. Cl. 312/410

(57) ABSTRACT

The present invention provides an improved chassis assembly structure for a griller. The lateral frames of the chassis assembly structure are provided with a rotary base for horizontal rotation an upper positioning rod is mounted at the top between lateral frames. A support structure for the chassis could be quickly assembled by joining the rotary base during assembly of the chassis. An upper positioning rod is combined, thus providing a major chassis structure. The present invention enables a user to assemble a frame of a chassis featuring time-saving and convenient assembly with greater efficiency.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a griller, and more particularly to a griller which has an innovative chassis assembly structure.

2. Description of Related Art Including Information Disclosed Under 37 CFR 1.97 and 37 CFR 1.98

The conventional large-sized grillers are typically comprised of a chassis, a stove and cover. The chassis is provided with an inner space for accommodating gas cans and other roasting utensils, making it possible to form an aesthetically pleasing griller structure.

The main objective of the present invention is to provide an improved chassis structure of the aforementioned griller. A typical chassis structure is generally comprised of lateral plates and bottom plates. The lateral plates are fixed securely with pivot bolt bolts. However, it is observed from actual applications that, the assembly is time-consuming and very difficult due to complicated and scattered components, making it impossible to set up a framework for the installers or users, or for convenient applications.

Thus, to overcome the aforementioned problems of the prior art, it would be an advancement in the art to provide an improved structure that can significantly improve efficacy.

To this end, the inventor has provided the present invention of practicability after deliberate design and evaluation based on years of experience in the production, development and design of related products.

### BRIEF SUMMARY OF THE INVENTION

The enhanced efficacy of the present invention is as follows:

Based upon an innovative structure, the lateral frames 10, 10B are provided with rotary base 20 for horizontal rotation. An upper positioning rod 30 is mounted at the top between lateral frames 10, 10B. A support structure for chassis A could be quickly assembled by joining the rotary base 20 during assembly of chassis A. Then, an upper positioning rod 30 is assembled, thus providing a major chassis A structure. As compared with the conventional structure described in the prior art, the present invention enables users to assemble a frame of chassis A featuring time-saving and convenient assembly with higher efficiency.

Moreover, the rotary base 20 could be folded into the lateral frames 10, 10B, such that the quantity and volume of removable components could be further reduced for convenient and space-saving applications.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows an exploded perspective view of chassis of the present invention.

FIG. 2 shows perspective views comparing the rotary base of the present invention in a shrunken state and expanded state.

FIG. 3 shows an assembled perspective view of chassis of the present invention from the front.

FIG. 4 shows an assembled perspective view of local components of chassis of the present invention.

FIG. 5 shows an exploded perspective view of the combination of curved faceplate and lateral frame of the present invention.

FIG. 6 shows an assembled perspective view of the combination of rotary ends of two rotary bases.

FIG. 7 shows the second assembled perspective view of chassis of the present invention from the rear.

FIG. 8 shows a top plan view of application of the chassis top complete with a stove.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

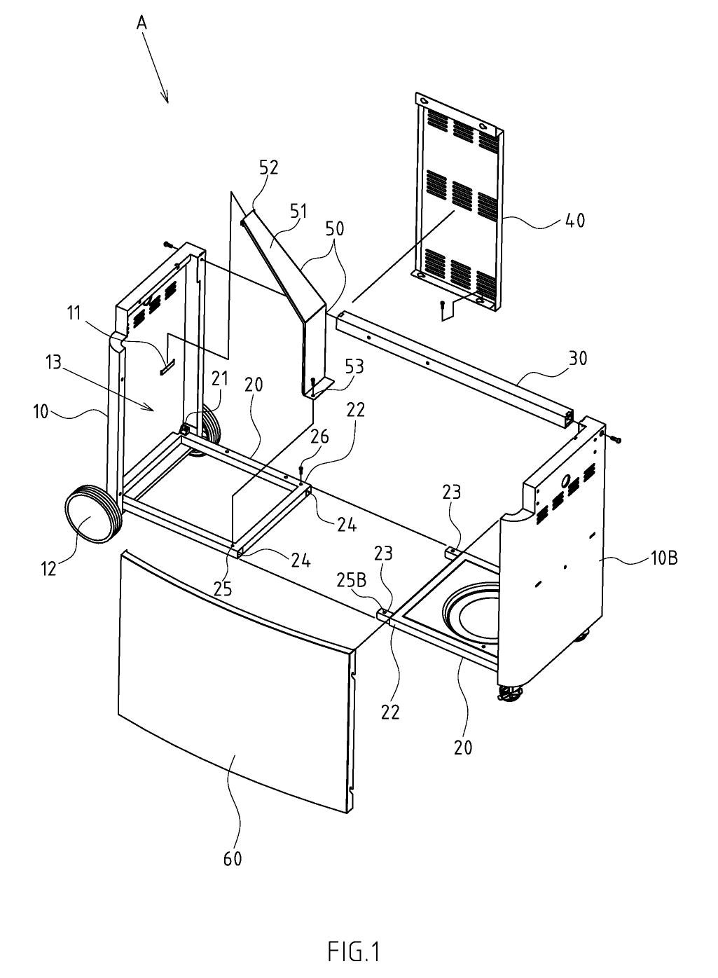

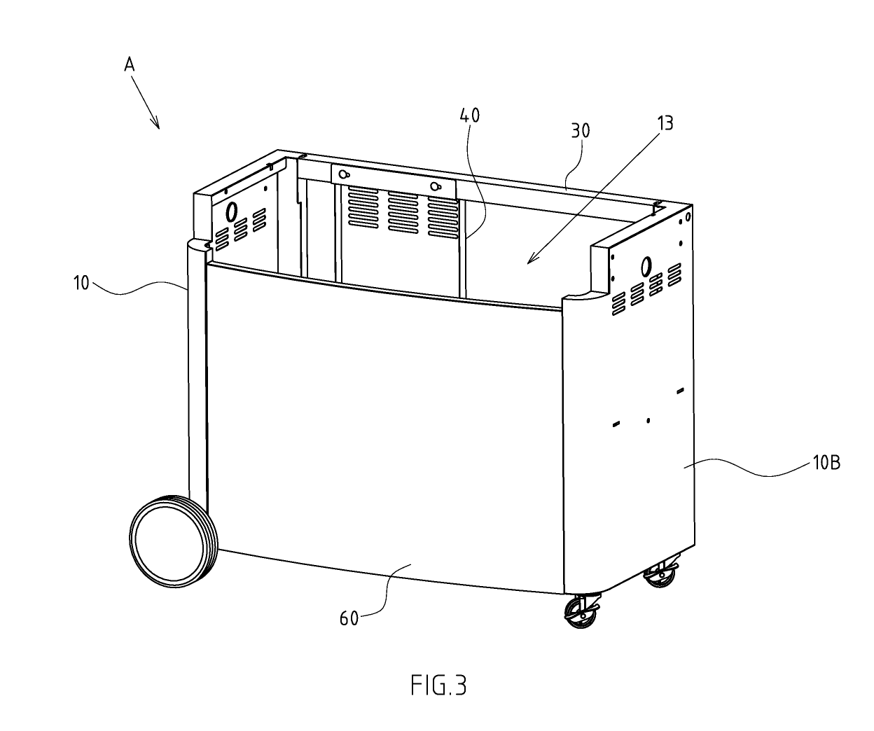

FIGS. 1, 2 and 3 depict preferred embodiments of an improved chassis assembly structure of the griller of the present invention. The embodiments are provided only for explanatory purpose of the patent claims.

The chassis assembly structure comprises two lateral frames 10, 10B, arranged vertically at two opposite surfaces of chassis A. With two rectangular plates, these two lateral frames 10, 10B are provided with an accommodating space 13 at inner side. A faceplate 60 is placed vertically at either side of two lateral frames 10, 10B, thus making it aesthetically pleasing and more reliable. A “ [symbol] -shaped” assembly portion 11 is mounted internally at a preset location of lateral frames 10, 10B, and a through groove 111 is formed onto the wall of assembly portion 11 opposite from two lateral frame 10, 10B. In addition, a roller 12 is mounted at bottom of two lateral frames 10, 10B for convenient movement.

A rotary base 20 is placed separately at the bottom of one or two lateral frames 10, 10B. One end of said rotary base 20 is fastened via a pivot bolt 21 at the bottom of accommodating space 13 of two lateral frames 10, 10B. A rotary end 22 is defined at the other end of the rotary base 20. The rotary base 20 rotates transversely, thus providing a support for the bottom of chassis A. In this preferred embodiment, a curved faceplate 50 is fixed at the included angle of two lateral frames 10, 10B and the rotary base 20, of which the curved faceplate 50 has a vertical and horizontal surfaces. At the bottom of the vertical surface, there is a positioning portion 53, which is located oppositely to fixing portions 25, 25B of the rotary base 20. So, a fixture 26 is assembled through the positioning portion 53 of curved faceplate 50, and then locked onto the rotary end 22 of rotary base 20. Moreover, the horizontal surface of curved faceplate 60 is made of a flat plate with an inclined angle, while a recessed assembly end 52 is defined at the extension end. The assembly end 52 is suspended by the through groove 111 of assembly portion 11 of either lateral frame 10 or 10B, such that the rotary base 20 could be positioned stably at an included angle. In addition, the vertical surface of curved faceplate 50 is provided with a horizontal face 51 for accommodating articles more efficiently. When two rotary bases 20 are arranged together, the rotary end 22 of two rotary bases 20 is fitted with male and female joint portions 23, 24 for positioning, where the fixing portions 25, 25B are placed at preset location on the top of male and female joint portions 23, 24, and also provided with female screws. After male and female joint portions 23, 24 are connected, a threaded fixture 26 is locked into the fixing portion 25, 25B, such that two lateral frames 10, 10B and two rotary bases 20 are fastened securely.

At least an upper positioning rod 30 is assembled transversely via a screw bolt onto at least one side of the top of two lateral frames 10, 10B, such that two end surfaces of the upper positioning rod 30 are fixed at a top surface of two lateral frames 10, 10B. A reinforcement plate 40 is mounted vertically between the upper positioning rod 30 and rotary base 20, to strengthen the overall frame of chassis A.

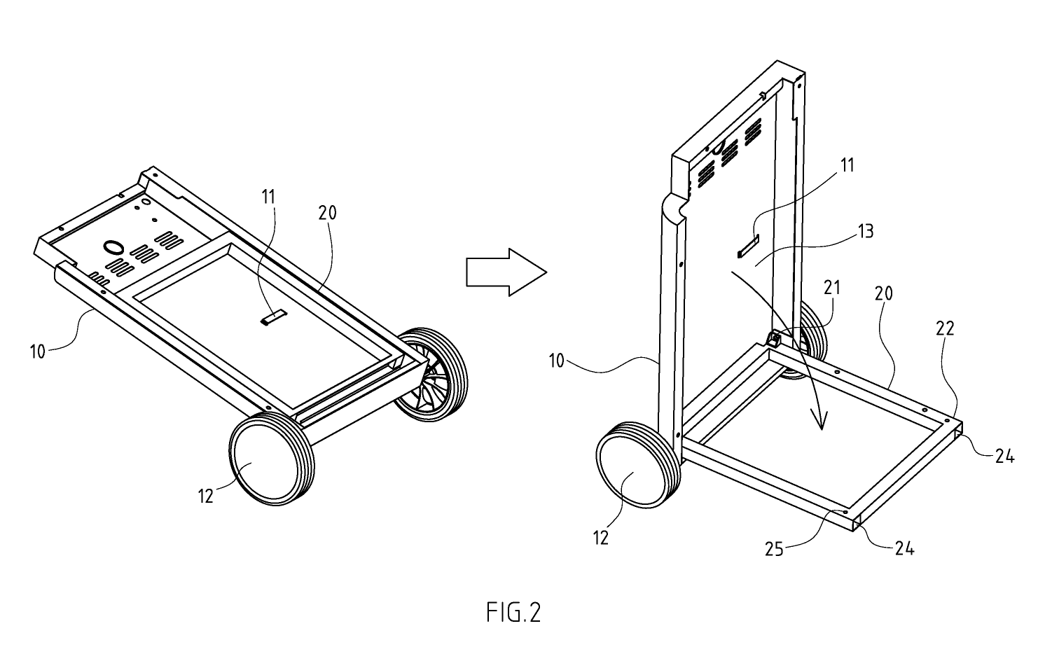

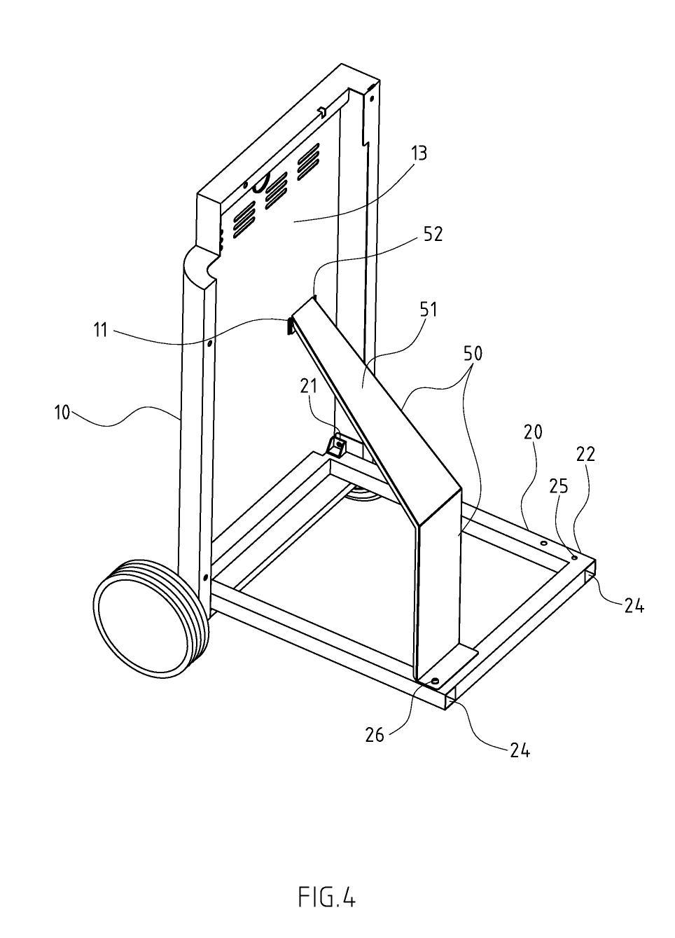

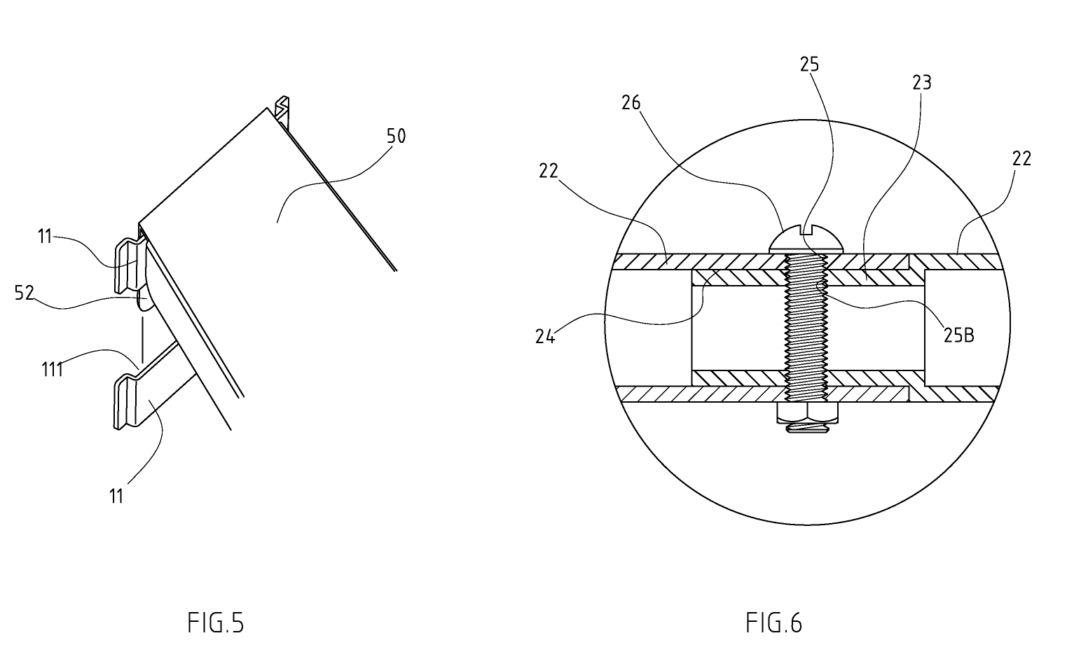

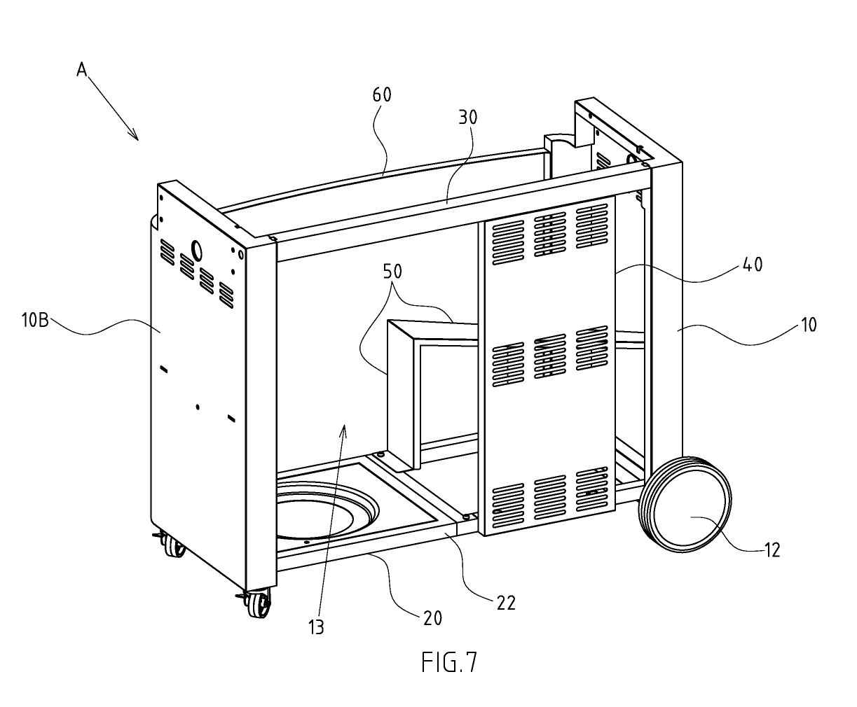

Based upon the above-specified structure, the present invention is operated as described herein. When chassis A is to be assembled, the rotary base 20 of two lateral frames 10, 10B, with the help of pivot bolt 21, enables the rotary end 22 of rotary base 20 to be extended by rotation from the accommodating space 13 and positioned at one side (shown in FIG. 2). The male and female joint portions 23, 24 of the rotary end 22 of rotary base 20 are connected, and also fastened via preset fixture 26 (e.g. bolt and nut) onto fixing portions 25, 25B (shown in FIG. 6), such that two lateral frames 10, 10B and two rotary bases 20 are positioned securely. At least an upper positioning rod 30 is arranged transversely via screw bolt onto at least one side of the top of two lateral frames 10, 10B, thus forming a 3D reference structure. A reinforcement faceplate 60 is horizontally installed between two lateral frames 10, 10B, and also a reinforcement plate 40 is vertically installed between the upper positioning rod 30 and rotary base 20, to strengthen the overall frame of chassis A. A curved faceplate 50 is placed at an included angle between two lateral frames 10, 10B and rotary base 20. The assembly end 52 is suspended by the through groove 111 of assembly portion 11 of two lateral frames 10, 10B (shown in FIG. 5), such that the positioning portion 53 is locked into fixing portions 25, 25B of rotary base 20. A rotary base 20 is enabled to be positioned stably at an included angle (shown in FIG. 4).

When chassis A is to be removed, the positioning portion 53 of curved faceplate 50 needs to dismantle the fixture 26 from the fixing portions 25, 25B of rotary base 20. The curved faceplate 50 faces upwards, such that the assembly end 52 is separated from through groove 111 of two lateral frames 10, 10B. Then, vertical faceplate 60 and reinforcement plate 40 are removed from two lateral frames 10, 10B and upper positioning rod 30, while two ends of upper positioning rod 30 are disengaged from the top of two lateral frames 10, 10B. After the fixture 26 of two rotary bases 20 are loosened from the rotary end 22, the male and female joint portions 23, 24 of rotary ends 22 are separated horizontally, such that the rotary base 20 is placed into the accommodating space 13 of two lateral frames 10, 10B via pivot bolt 21.

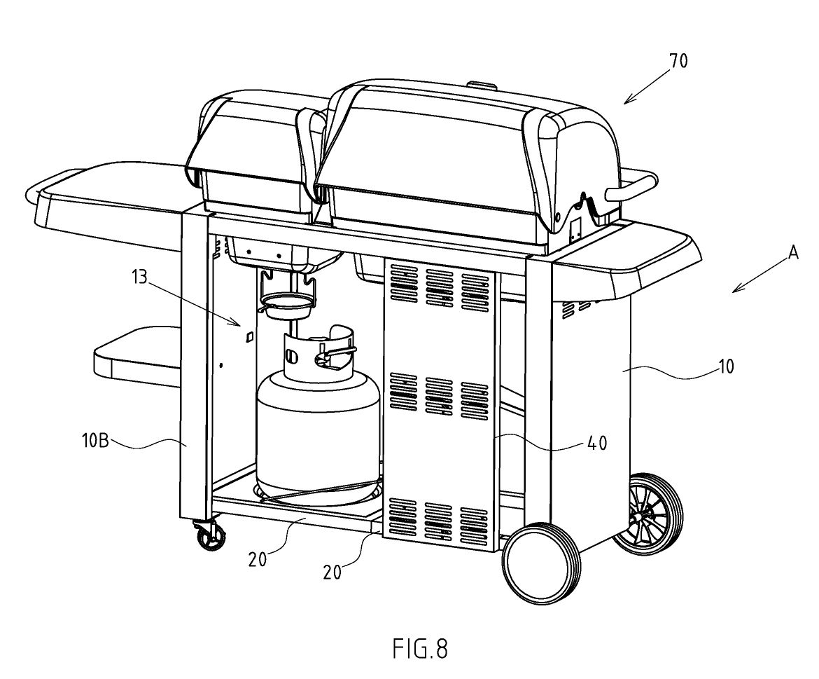

Referring to FIG. 8, chassis A of the present invention is equipped with a stove 70 at the top surface for a complete griller. An inner space 13 of chassis A could accommodate gas cans, while the stove 70 of chassis A can provide space for grilling tools.

Additionally, male and female joint portions 23, 24 of the rotary end 22 of two rotary bases 20 could be positioned using beads or other flexible snaps.

1. A chassis assembly structure of a griller, comprising:
two lateral frames, placed vertically at two opposite surfaces;
a rotary base, placed separately at a bottom of one or two lateral frames, said rotary base having one end fastened via a pivot bolt at a bottom of the lateral frames, and a rotary end is defined at another end of said rotary base, said rotary base being able to be rotated transversely, providing a support; and
at least an upper positioning rod, assembled transversely onto at least one side of a top of said two lateral frames.

2. The chassis assembly structure defined in claim 1, further comprising:
a vertical faceplate is mounted at either side of said two lateral frames.

3. The chassis assembly structure defined in claim 1, further comprising:
a reinforcement plate placed vertically between the upper positioning rod and said rotary base.

4. The chassis assembly structure defined in claim 1, wherein said rotary end of two rotary bases is provided with male and female joint portions, when two rotary bases are arranged together.

5. The chassis assembly structure defined in claim 1, further comprising:
a curved faceplate placed between the rotary end and a lateral frame, when said rotary base is arranged transversely.
